(19) United States
(12) Patent Application Publication
(10) Pub. No.: US 2025/0164611 A1
(43) Pub. Date: May 22, 2025

(54) OPTICAL RADAR DEVICE, LIGHT SOURCE STRUCTURE AND THE ASSEMBLY PROCESS THEREOF

(71) Applicant: Asia Optical Co., Inc., Taichung (TW)

(72) Inventors: Chin-Ping Lin, Taichung (TW); Cheng-Pang Wu, Taichung (TW); Jiunn-Jye Luo, Taichung (TW); Kuo-Shun Huang, Taichung (TW); Yung-Hsiao Huang, Taichung (TW); Wen-Lung Hsu, Taichung (TW)

(21) Appl. No.: 18/934,400

(22) Filed: Nov. 1, 2024

(30) Foreign Application Priority Data
Nov. 20, 2023 (TW) 112144758
Mar. 27, 2024 (TW) 113111477

(51) Int. Cl. G01S 7/481; G01S 17/32

(52) U.S. Cl. CPC G01S 7/4814; G01S 7/4813; G01S 7/4817; G01S 17/32

(57) ABSTRACT

An optical radar device, a light source structure and the assembly process thereof are provided. The light source structure includes a light source module, a circuit board, a cover and a beam adjusting module. The light source module includes a substrate that includes a bearing surface, and a light source element that is disposed on the bearing surface and includes light emitting units. Each light emitting unit includes a light emitting portion. The light source module is disposed on the circuit board. The cover, disposed on the circuit board to cover the light source module, is a continuous piece and includes a light permeable portion that is disposed to face the light permeable portion. The beam adjusting module is disposed close to the light permeable portion. Light emitted from the light emitting portion passes through the light permeable portion and the beam adjusting module to form a working light beam.

### BACKGROUND OF THE INVENTION

### Field of the Invention

The invention relates to a technical field of a laser ranging equipments, and more particularly to a light source structure that is a package structure formed by a light source array including multiple light sources, an optical radar device including the light source structure, and a process of assembling the light source structure.

### Description of the Related Art

An optical radar device (also named lidar) involves a technology that uses pulsed laser light to measure the distance of objects. A laser beam is emitted to a target and is reflected by the surface of the target. The reflected laser beam is received so that the distance to the target can be obtained through ranging technology (such as ToF technology or FMCW technology). Optical radar devices are widely used in meteorology, terrain detection, or a ranging application for autonomous vehicle that is currently popular.

Generally, what are used as the light source structure of a known optical radar device are laser diodes. Multiple laser diodes are arranged into an array on a circuit board to emit laser beams at a predetermined frequency for measuring the distance to an object. In such laser light source structure, however, the laser diodes are individually welded to the circuit board. To ensure that the irradiation direction of the beam can meet the requirements, the laser diode array is checked by way of beam projections in the subsequent alignment and correction process. Further, the beam emitted by the laser diode array in a direction parallel to the circuit board additionally requires prisms to change the traveling direction. Therefore, the manufacturing process of known optical radar devices is relatively complex and the beam irradiation direction is easily affected by the manufacturing process. Further, known optical radar devices have a large number of components and are difficult to be miniaturized.

### BRIEF SUMMARY OF THE INVENTION

An object of the invention is to provide an optical radar device and its light source structure, which can achieve the required accuracy of the light emission of the light source structure with a relatively simple manufacturing process.

The light source structure in accordance with an exemplary embodiment of the invention includes a light source module, a circuit board, a cover and a beam adjusting module. The light source module includes a substrate and at least one light source element, wherein the substrate includes a bearing surface, the light source element is disposed on the bearing surface and includes a plurality of light emitting units, and each of the light emitting units includes a light emitting portion. The light source module is disposed on the circuit board. The cover is disposed on the circuit board to cover the light source module, wherein the cover is a continuous piece and includes a light permeable portion, and the light emitting portion is disposed to face the light permeable portion. The beam adjusting module is disposed close to the light permeable portion of the cover, wherein light emitted from the light emitting portion passes through the light permeable portion and the beam adjusting module to form a working light beam.

In another exemplary embodiment, the light emitting units are individually controlled to emit the light, the light is emitted by the light emitting portion in a light emitting direction, the bearing surface of the substrate is perpendicular to the circuit board, the light emitting direction is away from and perpendicular to the circuit board, the light permeable portion of the cover is a plane lens, the substrate has electrical insulation and thermal conductivity, and heat generated by the light emitting units during operation is conducted to the substrate to be dissipated.

In yet another exemplary embodiment, the light source module includes a plurality of light source elements arranged into an light source array, each of the light source elements have the same number of light emitting units or a different number of light emitting units, and the light emitting units are semiconductor light emitting units.

In another exemplary embodiment, the light emitting units of each of the light source elements are greater than or equal to two and less than or equal to eight in number, and the light emitting units are laser diode dice or vertical cavity surface emitting laser.

In yet another exemplary embodiment, the light emitting units of each of the light source elements are four in number.

In another exemplary embodiment, the light source array includes a first side, a second side, a third side and a fourth side, the first side is disposed opposite to the fourth side, the second side is disposed opposite to the third side, the first side is disposed next to the second side and the third side. The light source further includes a first electrode layer and a second electrode layer, the first electrode layer and the second electrode layer are disposed on the bearing surface of the substrate, the first electrode and the second electrode layer are electrically connected to the circuit board, the first electrode layer is disposed adjacent to the first side of the light source array, the second electrode layer is disposed adjacent to the second side and the third side of the light source array, and the light emitting portion is disposed adjacent to the four side of the light source array.

In yet another exemplary embodiment, the beam adjusting module includes a fast axis collimator disposed adjacent to the light permeable portion of the cover, and the light emitted from the light emitting portion sequentially passes through the light permeable portion and the fast axis collimator.

In another exemplary embodiment, the beam adjusting module further includes a slow axis collimator integrally formed with the fast axis collimator to be a continuous structure, and the light emitted from the light emitting portion sequentially passes through the light permeable portion, the fast axis collimator and the slow axis collimator.

In yet another exemplary embodiment, the fast axis collimator includes a convex lens portion and a first columnar portion connected to the convex lens portion, the slow axis collimator includes a concave lens portion and a second columnar portion connected to the concave lens portion, the first columnar portion and the second columnar portion are connected, the light sequentially passes through the convex lens portion, the first columnar portion, the second columnar portion, and the concave lens portion, the convex lens portion is configured to deflect the light in a first direction, the concave lens portion is configured to deflect the light in a second direction, and the second direction is perpendicular to the first direction.

In another exemplary embodiment, the beam adjusting module includes a slow axis collimator, the slow axis collimator is disposed to face the light permeable portion of the cover, and the light emitted from the light emitting portion sequentially passes through the light permeable portion and the slow axis collimator.

In yet another exemplary embodiment, the light emitting portion has a horizontal width dx, a vertical width dy, a horizontal lighting angle θx and a vertical lighting angle θy. The horizontal width dx is a measurement parallel to the bearing surface. The vertical width dy is a measurement perpendicular to the bearing surface. The horizontal width dx satisfies 200 μm≤dx≤400 μm. The vertical width dy satisfies 0.5 μm≤dy≤15 μm. The horizontal lighting angle θx satisfies 8°≤θx≤15°. The vertical lighting angle θy satisfies 20°≤θx≤40°. A ratio of the vertical lighting angle θy to the horizontal lighting angle θx satisfies 2≤θy/θx≤4. Two adjacent light emitting portions are spaced at an interval, and has two center points that have a distance therebetween. A ratio of the interval to the distance is ranged from 20% to 40%.

In another exemplary embodiment, the light emitting portion has a horizontal width dx, a vertical width dy, a horizontal lighting angle θx and a vertical lighting angle θy. The horizontal width dx is a measurement parallel to the bearing surface. The vertical width dy is a measurement perpendicular to the bearing surface. The horizontal width dx satisfies 348.25 μm≤dx≤351.75 μm. The vertical width dy satisfies 0.995 μm≤dy≤1.005 μm. The horizontal lighting angle θx satisfies 9.95°≤θx≤10.05°. The vertical lighting angle θy satisfies 320.835°≤θy≤330.165°. Two adjacent light emitting portions are spaced at an interval, and has two center points that have a distance therebetween in a horizontal direction. The distance is greater than or equal to 497.5 μm, and is less than or equal to 502.5 μm. The interval is greater than or equal to 149.25 μm, and less than or equal to 150.75 μm.

The optical radar device in accordance with an exemplary embodiment includes a housing, the above-mentioned light source structure, a scanning element, a light receiving element, and a calculation control unit. The housing includes a transparent window. The light source structure as claimed in claim 1 that is disposed in the housing. The scanning element includes a plurality of reflecting mirrors and being rotatable about an axis. A light receiving element is disposed in the housing to face the window. A calculation control unit is electrically connected to the light source structure, the scanning element and the light receiving element. The working light beam is emitted from the light source structure, the scanning element is rotated so that the working light beam is reflected by one of the reflecting mirrors to an exterior through the window, an emission angle of the working light beam changes with time, the working light beam is reflected by an external object to be received by the light receiving element, and a distance of the external object is calculated by the calculation control unit based on information about emission and reception of the working light beam.

The invention provides an optical radar device and the light source structure thereof, wherein multiple light emitting units are provided to form a light source elements, multiple light source elements are provided to form a light source array, and the light source array is covered by a cover. The light emitting units are individually controlled to emit light. In this way, the accuracy of light beam emission can be increased, and the subsequent adjustment and calibration process of light beam projection can be simplified. The operation of welding laser diodes to the circuit board that is performed in the prior art is not required in the invention. Therefore, the assembly process can be simplified and the required accuracy can be easily reached.

Further, the light emitting direction of the light emitting portion of the light emitting unit is perpendicular to the circuit board. Therefore, no prisms for changing the traveling direction of the light beams are required. The elements of the light source structure can be reduced in number.

Another object of the invention is to provide an assembly process of a light source structure, which can achieve the required accuracy of light emission of the light source structure in a relatively simple process, and is conducive to the miniaturization of optical radar devices.

The assembly process of a light source structure in accordance with an exemplary embodiment of the invention includes steps of providing a substrate that includes a bearing surface; forming at least one light source element on the bearing surface wherein the light source element and the substrate constitute a light source module, the light source element includes a plurality of light emitting units, and each of the light emitting units includes a light emitting portion; providing a circuit board; installing the light source module on the circuit board; providing a cover that is a continuous piece and includes a light permeable portion; placing the cover on the circuit board to form an accommodating space, with the light source module disposed therein and the light emitting portion corresponded to the light permeable portion; forming the accommodating space into a vacuum space; providing a beam adjusting module; and placing the beam adjusting module corresponding to the light permeable portion so that light emitted from the light emitting portion can pass through the beam adjusting module to form a working light beam.

In another exemplary embodiment, the light emitting units are individually controlled to emit the light from the light emitting portion. The light emitting portions emit the light in the same direction. A plurality of light source elements are formed on the bearing surface. The light source elements are arranged into an array. The bearing surface of the substrate is perpendicular to the circuit board.

In yet another exemplary embodiment, the beam adjusting module includes a fast axis collimator and a slow axis collimator integrally formed with the fast axis collimator to be a continuous structure. The fast axis collimator includes a convex lens portion and a first columnar portion connected to the convex lens portion, the slow axis collimator includes a concave lens portion and a second columnar portion connected to the concave lens portion, and the first columnar portion and the second columnar portion are connected to be another continuous structure. The fast axis collimator is disposed adjacent to the light permeable portion of the cover. The first columnar portion is disposed adjacent to the light permeable portion of the cover.

In another exemplary embodiment, the light emitting units are less than or equal to eight in number. The beam adjusting module includes a slow axis collimator. The slow axis collimator is disposed adjacent to the light permeable portion of the cover.

In yet another exemplary embodiment, the light emitting units are four in number.

In another exemplary embodiment, the light emitting portion has a horizontal width dx, a vertical width dy, a horizontal lighting angle θx and a vertical lighting angle θy. The horizontal width dx is a measurement parallel to the bearing surface. The vertical width dy is a measurement perpendicular to the bearing surface. The horizontal width dx satisfies 200 μm≤dx≤400 μm. The vertical width dy satisfies 0.5 μm≤dy≤15 μm. The horizontal lighting angle θx satisfies 8°≤θx≤15°. The vertical lighting angle θy satisfies 20°≤θx≤40°. A ratio of the vertical lighting angle θy to the horizontal lighting angle θx satisfies 2≤θy/θx≤4. Two adjacent light emitting portions are spaced at an interval, and has two center points that have a distance therebetween. A ratio of the interval to the distance is ranged from 20% to 40%.

In yet another exemplary embodiment, the light emitting portion has a horizontal width dx, a vertical width dy, a horizontal lighting angle θx and a vertical lighting angle θy. The horizontal width dx is a measurement parallel to the bearing surface. The vertical width dy is a measurement perpendicular to the bearing surface. The horizontal width dx satisfies 348.25 μm≤dx≤351.75 μm. The vertical width dy satisfies 0.995 μm≤dy≤1.005 μm. The horizontal lighting angle θx satisfies 9.95°≤θx≤10.05°. The vertical lighting angle θy satisfies 32.835°≤θy≤33.165°. Two adjacent light emitting portions are spaced at an interval, and has two center points that have a distance therebetween in a horizontal direction. The distance is greater than or equal to 497.5 m, and is less than or equal to 502.5 μm. The interval is greater than or equal to 149.25 μm, and less than or equal to 150.75 μm.

The invention provides an assembly process of a light source structure, wherein multiple light emitting units are provided to form a light source elements, multiple light source elements are provided to form a light source array, and the light source array is covered by a cover. The light emitting units are individually controlled to emit light. In this way, the accuracy of light beam emission can be increased, and the subsequent adjustment and calibration process of light beam projection can be simplified. The operation of welding laser diodes to the circuit board that is performed in the prior art is not required in the invention. Therefore, the assembly process can be simplified and the required accuracy can be easily reached.

Further, the light emitting direction of the light emitting portion of the light emitting unit is perpendicular to the circuit board. Therefore, no prisms for changing the traveling direction of the light beams are required. The elements of the light source structure can be reduced in number.

The fast axis collimator and the slow axis collimator of the beam adjusting module are integrally formed into a continuous structure, which can achieve the required accuracy of light emission of the light source structure in a relatively simple process, reduce the number of elements of the light source structure, and is conducive to the miniaturization of optical radar devices. The operation of individually placing the fast axis collimator and the slow axis collimator and the subsequent adjustment and calibration of the fast axis collimator and the slow axis collimator that are performed in the prior art is not required in the invention.

### BRIEF DESCRIPTION OF THE DRAWINGS

FIG. 1 is a perspective view of a light source module of a light source structure in accordance with the invention.

FIG. 2 is a perspective view of a light source array of the light source module of FIG. 1.

FIGS. 3 and 4 are perspective views showing a cover of the light source structure of the invention that is disposed on a circuit board to cover the light source module.

FIG. 5 is a top view showing a beam adjusting module of the light source structure of the invention that is disposed corresponding to the light permeable portion of the cover.

FIG. 6 is a side view of the light source module, the light permeable portion of the cover, and the beam adjusting module of FIG. 5.

FIG. 7 is a perspective view of an optical radar device in accordance with an embodiment of the invention.

FIG. 8 is a flowchart showing the assembly process of the light source structure in accordance with an embodiment of the invention.

FIG. 9 is a perspective view showing the light source module after assembly by the assembly process of the light source structure of the invention.

### DETAILED DESCRIPTION OF THE INVENTION

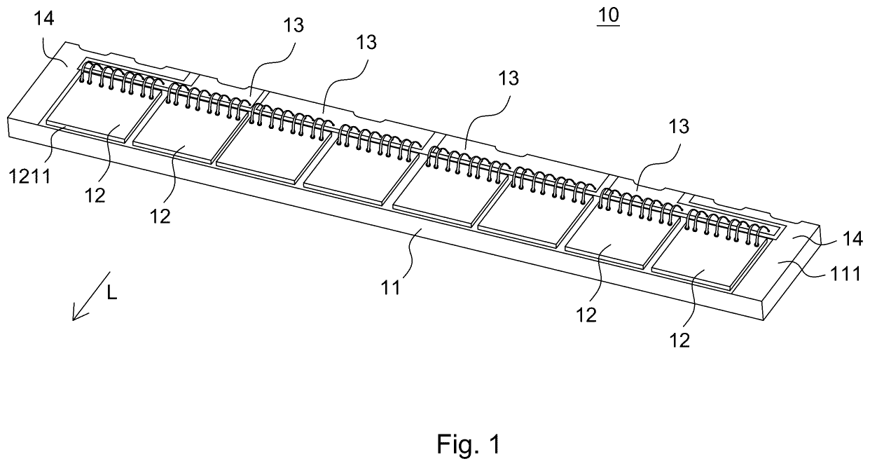

Referring to FIGS. 1-7, a light source structure 1 of an embodiment of the invention includes a light source module 10, a circuit board 20, a cover 30 and a beam adjusting module 40.

As shown in FIG. 1, the light source module 10 includes a substrate 11, multiple light source elements 12, a first electrode layer 13, and a second electrode layer 14. The substrate 11 has a bearing surface 111, with the light source elements 12, the first electrode layer 13 and the second electrode layer 14 formed thereon by, for example, chemical vapor deposition (CVD). The substrate 11 of this embodiment may be an aluminum nitride (AlN) substrate. The aluminum nitride substrate has properties of good electrical insulation and good thermal conductivity. In other words, the aluminum nitride substrate is a structure with good electrical insulation property provided for the light source element 12, the first electrode layer 13 and the second electrode layer 14. Also, the heat generated by the light source element 12 during operation can be transmitted to the outside through thermal conduction through the aluminum nitride substrate to be dissipated.

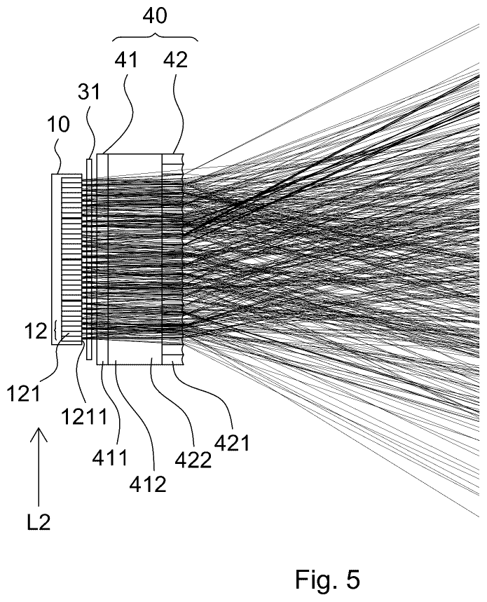

The light source elements 12 are arranged into a light source array. Each light source element 12 has a plurality of light emitting units 121 as shown in FIG. 5. The light emitting units 121 of this embodiment are semiconductor light emitting elements (specifically laser diode dice or vertical cavity surface emitting laser, VCSEL). In this embodiment, each light source element 12 has four light emitting units 121 to maximize the yield rate. The number of light emitting units 121 of each light source element 12 is greater than or equal to two and less than or equal to eight. Each light source element 12 of the light source array A may have the same number of light emitting units 121 or a different number of light emitting units 121. For example, each light source element 12 has four light emitting units 121. For another example, at least one light source element 12 has two light emitting units 121, at least another light source element 12 has three light emitting units 121, and at least another light source element 12 has four light emitting units 121.

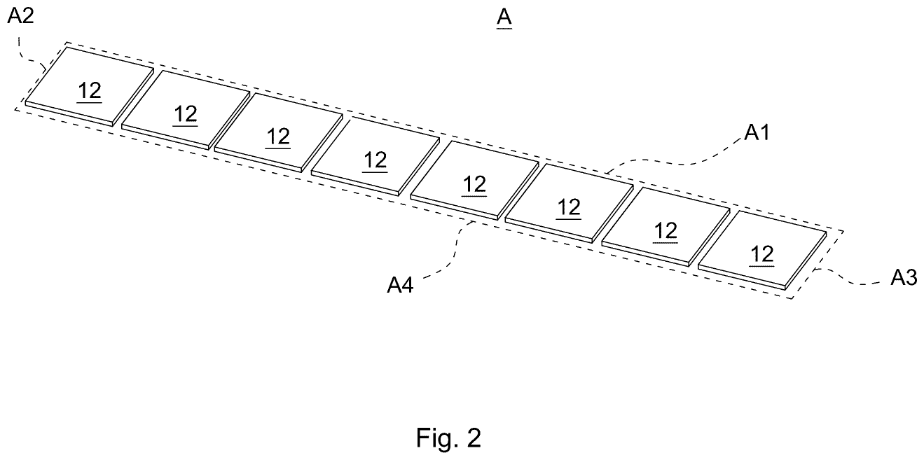

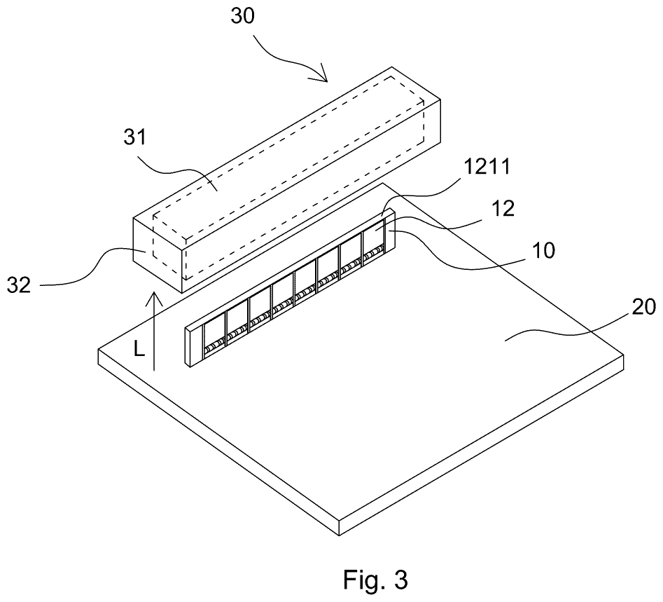

Referring to FIGS. 2 and 3, the light source array A has a first side A1, a second side A2, a third side A3 and a fourth side A4. The first side A1 is disposed opposite to the fourth side A4. The second side A2 is disposed opposite to the third side A3. The first side A1 is disposed next to the second side A2 and the third side A3. The fourth side A4 is also disposed next to the second side A2 and the third side A3. The first electrode layer 13 is disposed adjacent to the first side A1 of the light source array A. The second electrode layer 14 is disposed adjacent to the second side A2 and the third side A3. The first electrode 13 and the second electrode layer 14 are electrically isolated from each other.

Each light emitting unit 121 has a P-type semiconductor, an N-type semiconductor, and a light-emitting layer (active layer) disposed between the P-type semiconductor and the N-type semiconductor. The N-type semiconductor is electrically connected to the first electrode layer 13. The P-type semiconductor is electrically connected to the second electrode layer 14. The light emitting layer has a light emitting portion 1211 formed at the fourth side A4 of the light source array A. All the light emitting portions 1211 of the light emitting units 121 are configured to emit light in a light emitting direction L. The light generated by the electrons and electron holes in the light emitting layer is emitted from the light emitting portion 1211 in the light emitting direction L. The N-type semiconductor of each light emitting unit 121 is connected to the first electrode layer 13 with two pins. One pin is configured to provide an electric current, and the other pin is configured to control whether the light emitting layer lights up, so that the light emitting units 121 can be individually controlled to emit light.

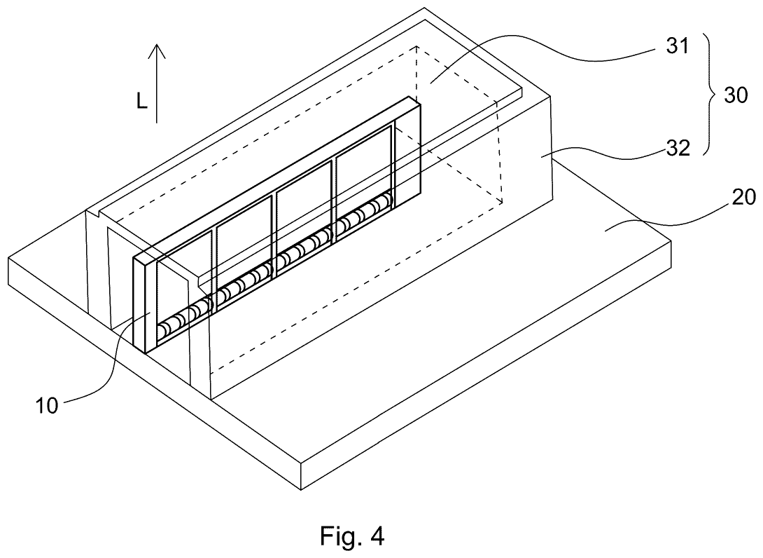

Referring to FIGS. 3 and 4, the light source module 10 is disposed on the circuit board 20. The first electrode layer 13 and the second electrode layer 14 are electrically connected to the circuits of the circuit board 20. By such arrangement, the circuits of the circuit board 20 can provide electric currents for the light source module 10 and control the light source module 10 to emit light. The bearing surface 111 of the substrate 11 of the light source module 10 is perpendicular to the circuit board 20. The first side A1 of the light source array A is disposed close to the circuit board 20. The fourth side A4 of the light source array A is disposed distant from the circuit board 20. By such arrangement, the light emitting direction L of the light emitting portion 1211 of the light emitting unit 121 is perpendicular to the circuit board 20 without requiring any prisms to change the light path.

A cover 30 is disposed on the circuit board 20 to cover the light source module 10. In this embodiment, the cover 30 has a light permeable portion 31 and side walls 32 configured to surround the light source module 10. The light permeable portion 31 is disposed at an end of the side walls and corresponded to the light emitting portion 1211 of the light emitting unit 121 of the light source module 10. The light emitting direction L of the light emitting portion 1211 of the light emitting unit 121 extends through the light permeable portion 31. In this embodiment, the light permeable portion 31 is a plane lens. For example, the light permeable portion 31 is a double-sided coated plane lens to avoid light reflection.

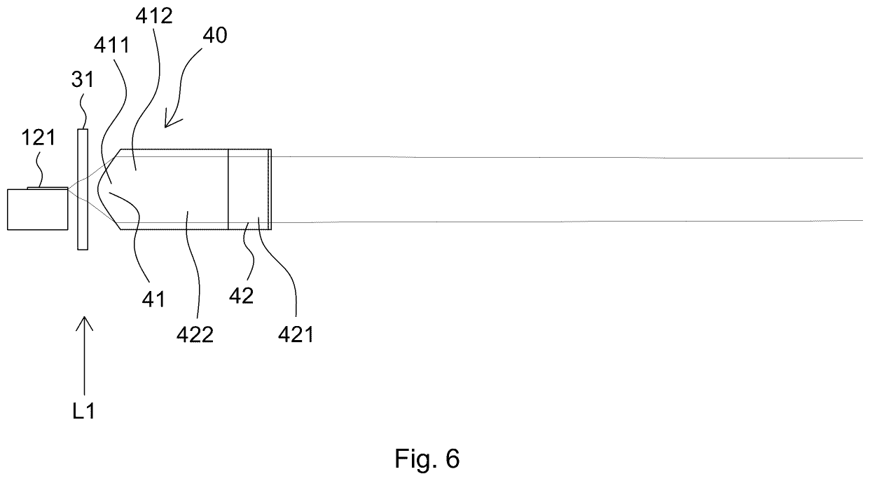

As shown in FIGS. 5 and 6, the beam adjusting module 40 is disposed close to the light permeable portion 31 of the cover 30. The light emitted from the light emitting portion 1211 of the light emitting unit 121 passes through the beam adjusting module 40 to form light beams. In this embodiment, the beam adjusting module 40 includes a fast axis collimator 41 and a slow axis collimator 42. The fast axis collimator 41 can converge the light emitted by the light source module 10 at a large angle before the light diverges. The slow axis collimator 42 adjusts the light pattern of the light collected by the fast axis collimator 41 to meet application requirements. The slow axis collimator 42 is connected to the fast axis collimator 41. In this embodiment, the slow axis collimator 42 and the fast axis collimator 41 are integrally formed into a continuous structure. In this way, the adjustment and calibration between the fast axis collimator 41 and the slow axis collimator 42 is finished at the same time as the beam adjusting module 40 is manufactured, which can simplify the subsequent adjustment and calibration process. One of the preferred embodiments of the beam adjusting module 40 is described above. However, the invention is not limited thereto. It is understood that the effect of the invention can also be achieved when only the fast axis collimator 41 or only the slow axis collimator 42 is provided, either of which can be regarded as one of the embodiments of the invention. When only the fast axis collimator 41 is provided in the beam adjusting module 40, the pattern of the light beam cannot be adjusted. However, the beam divergence angle can be increased to cover more area of the target. The longer the light beam is moved, the larger the area of the light spot is. Therefore, the areas of the target to be covered can be still increased. When only the slow axis collimator 42 is provided in the beam adjusting module 40, the light received by the beam adjusting module 40 has not been converged. However, if the slow axis collimator 42 and the light emitting exit surface are disposed close to each other, then the light emitted by the light source module 10 will have an opportunity to enter the slow axis collimator 42 before divergence, thereby achieving the effect of the invention.

In this embodiment, the fast axis collimator 41 includes a columnar convex lens. The columnar convex lens may have an aspheric surface (such as paraboloidal surface). The slow axis collimator 42 includes a columnar concave lens. The columnar concave lens has a microstructure formed by an array of concave lenses with multiple aspheric surfaces (such as paraboloidal surfaces). In some other embodiments, the fast axis collimator 41 may be a spherical convex lens, and the slow axis collimator 42 may be a spherical concave lens.

In this embodiment, the fast axis collimator 41 and the slow axis collimator 42 are combined in such a way that the beam adjusting module 40 is formed into a continuous structure, wherein the fast axis collimator 41 includes a convex lens portion 411 and a first columnar portion 412, and the slow axis collimator 42 includes a concave lens portion 421 and a second columnar portion 422. The concave lens portion 421 has a microstructure provided with multiple concave lenses. The convex lens portion 411 and the concave lens portion 421 are disposed at two opposite ends of the beam adjusting module 40 that has a continuous structure. The first columnar portion 412 and the second columnar portion 422 are connected to each other. The convex lens portion 411 of the fast axis collimator 41 is disposed to face the light permeable portion 31. The light emitted from the light source module 10 passes through the light permeable portion 31 and the convex lens portion 411 of the fast axis collimator 41. Before diverging, the light is converged by the convex lens part 411 in the fast axis direction (first direction L1). Then, the light passes through the first columnar portion 412 and the second columnar portion 422, both of which have no refractive power, and passes through the concave lens portion 421. The concave lens portion 421 causes an appropriate degree of divergence of light in the second direction L2. The second direction L2 is perpendicular to the first direction L1.

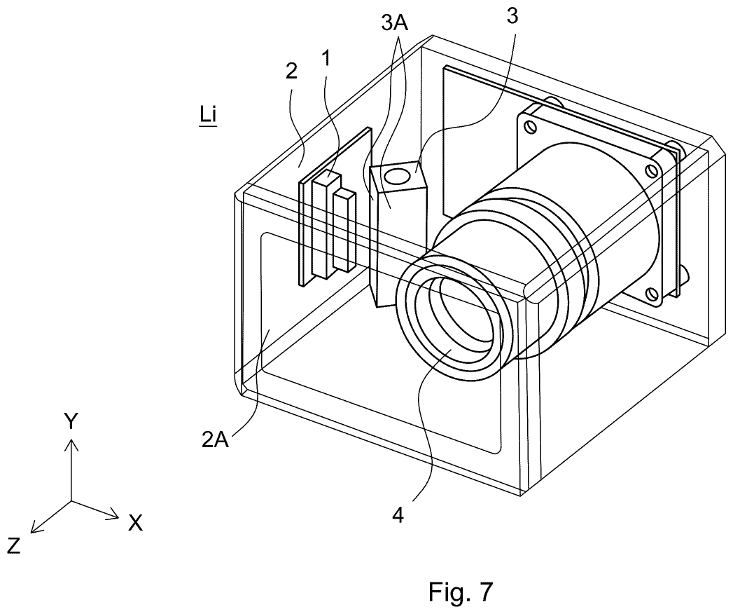

Referring to FIG. 7, an optical radar device Li of this embodiment includes a light source structure 1, a housing 2, a scanning element 3, a light receiving element 4, and a calculation control unit (not shown). The housing 2 has a hollow rectangular parallelepiped structure with the light source structure 1, the scanning element 3, and the light receiving element 4 disposed therein. The calculation control unit may be a calculator device disposed outside the housing 2. The housing 2 has a transparent window 2A on its side wall, which allows the working light beam generated by the light source structure 1 to be emitted to the outside, and allows the working light beam reflected by an object to return to the optical radar device Li.

The scanning element 3 includes multiple reflecting mirrors 3A that are connected to form a columnar structure. The scanning element 3 is rotatable about an axis. The light source structure 1 is able to emit a working light beam at a predetermined frequency. The scanning element 3 rotates so that one of the reflecting mirrors 3A reflects the working light beam to the outside through the window 2A, and the emission angle of the working light beam changes with time, whereby a scan is performed within a certain angle range relative to the horizontal direction (X-axis) of the optical radar device. Since the concave lens portion 421 of the beam adjusting module 40 causes the light to diverge to an appropriate degree in the second direction L2, the divergence angle may be, but is not limited to, 32 degrees or 60 degrees. The second direction L2 is parallel to the perpendicular direction (Y-axis) of the optical radar device. In this way, when the scanning element 3 rotates, light can scan the external space in the X-axis and Y-axis directions. Since the working light beam travels along the Z-axis, a three-dimensional scanning effect can be produced. As described, multiple reflecting mirrors 3A are connected to each other to form a columnar structure. Therefore, when the scanning element 3 rotates about the axis, the reflection of the working light beam by the reflecting mirror 3A is periodical to form a loop, so that the scan of the working light beam can be periodically performed within a certain angular range.

The light receiving element 4 is disposed in the housing to face the transparent window 2A. Therefore, the working light beam reflected by an external object can be received by the light receiving element 4. The calculation control unit is electrically connected to the light source structure 1, the scanning element 3 and the light receiving element 4. The distance to the external object can be calculated by the calculation control unit based on the information about emission and reception of the working light beam.

The invention provides an optical radar device and the light source structure thereof, wherein multiple light emitting units are provided to form a light source elements, multiple light source elements are provided to form a light source array, and the light source array is covered by a cover. The light emitting units are individually controlled to emit light. In this way, the accuracy of light beam emission can be increased, and the subsequent adjustment and calibration process of light beam projection can be simplified. The operation of welding laser diodes to the circuit board that is performed in the prior art is not required in the invention. Therefore, the assembly process can be simplified and the required accuracy can be easily reached.

Further, the light emitting direction of the light emitting portion of the light emitting unit is perpendicular to the circuit board. The slow axis collimator of the beam adjusting module deflects the light on the Y-axis, and the scanning element deflects the light on the X-axis. Therefore, no prisms for changing the traveling direction of the light beams are required. The elements of the light source structure can be reduced in number.

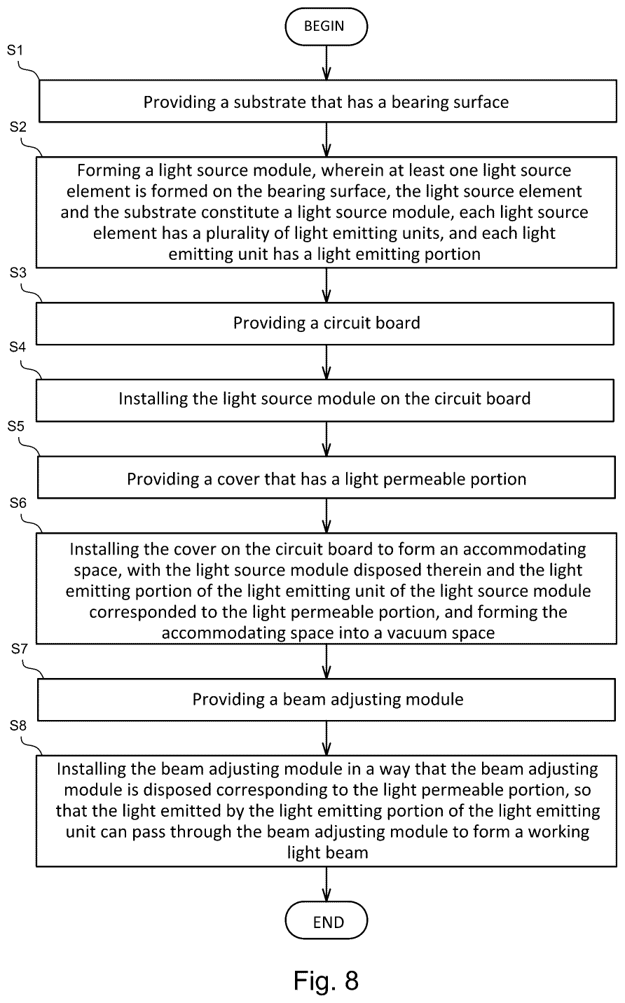

FIG. 8 is a flowchart showing the assembly process of the light source structure in accordance with an embodiment of the invention. In this embodiment, the assembly process of the light source structure is used for assembling the light source structure of an optical radar device. However, the light source structure of the invention is not limited to that of the optical radar device. The light source structure of the invention is applicable to other laser ranging equipments.

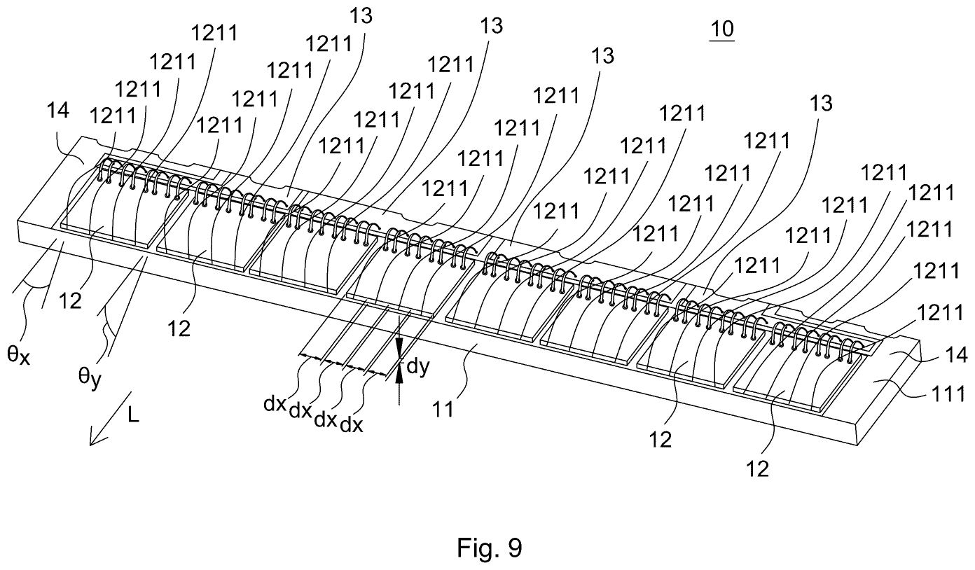

Step S1 is a step for providing a substrate 11 that has a bearing surface 111 as shown in FIG. 9. The substrate 11 may be an aluminum nitride (AlN) base material. The aluminum nitride base material has good electrical insulation and good thermal conductivity.

The process goes to step S2. Step S2 is a step of forming a light source module. In the step S2, at least one light source element 12 is formed on the bearing surface 111. The light source element 12 and the substrate 11 constitute a light source module 10. Each light source element 12 has a plurality of light emitting units 121. Each light emitting unit 121 has a light emitting portion 1211. In this embodiment, each light emitting portion 1211 has a horizontal width dx, a vertical width dy, a horizontal lighting angle θx and a vertical lighting angle θy. The horizontal width dx is a measurement parallel to the bearing surface. The vertical width dy is a measurement perpendicular to the bearing surface. The range of the horizontal width dx is 200 μm≤dx≤400 μm. A preferred horizontal width dx is 350 μm. Under the condition that the measurement tolerance is ±0.5%, a preferred range of the horizontal width dx is 348.25 μm≤dx≤351.75 μm. The range of the vertical width dy is 0.5 μm≤dy≤15 μm. A preferred vertical width dy is 1 μm. Under the condition that the measurement tolerance is ±0.5%, a preferred range of the vertical width dy is 0.995 μm≤dy≤1.005 μm. The range of the horizontal lighting angle θx is 8°≤θx≤15°. A preferred horizontal lighting angle θx is 10°. Under the condition that the measurement tolerance is ±0.5%, a preferred range of the horizontal lighting angle θx is 9.95°≤θx≤10.05°. The range of the vertical lighting angle θy is 20°≤θx≤40°. A preferred vertical lighting angle θy is 33°. Under the condition that the measurement tolerance is ±0.5%, a preferred range of the vertical lighting angle θy is 32.835°≤θy≤33.165°.

The process goes to step S3. In order to enable the light source element 12 to operate, the light source module 10 further includes a first electrode layer 13 and a second electrode layer 14. The step of forming the light source module further includes forming the first electrode layer 13 and the second electrode layer 14 on the bearing surface 111 of the substrate 11 by, for example, chemical vapor deposition (CVD).

The step of forming a light source module (step S2) further includes forming multiple light source elements 12 on the bearing surface 111 and arranging the light source elements 12 into an array A. Each light source element 12 includes a plurality of light emitting units 121 shown in FIG. 5. In this embodiment, the light emitting unit 121 is a laser diode die. When the horizontal lighting angle θx and the vertical lighting angle θy satisfy the condition 4≤θy/θx≤2, the utilization rate of laser energy is comparatively high. In this embodiment, the yield rate is optimized when each light source element 12 has four light emitting units 121. Generally, the number of the light emitting units 121 of each light source element 12 is greater than or equal to two, and is less than or equal to eight. In a light source array A, each light source element 12 may have the same number of light emitting units 121 or a different number of light emitting units 121. For example, each light source element 12 has four light emitting units 121. For another example, a light source element 12 has two light emitting units 121, another light source element 12 has three light emitting units 121, and another light source element 12 has four light emitting units 121. In each light source element 12, the distance D between the center points of two adjacent light emitting portions 1211 in the horizontal direction is 500 μm. Under the condition that the measurement tolerance is ±0.5%, the distance D between the center points of two adjacent light emitting portions 1211 in the horizontal direction is greater than or equal to 497.5 μm, and is less than or equal to 502.5 μm. Further, two adjacent light emitting portions 1211 are spaced at an interval of 150 μm. Under the condition that the measurement tolerance is ±0.5%, the range of the interval is greater than or equal to 149.25 μm, and less than or equal to 150.75 μm. In order to prevent that two adjacent light emitting portions 1211 are too close thereby interfering with each other and affecting the size of the beam adjusting module 40 (described below), a preferred ratio of the interval to the distance is ranged from 20% to 40%.

As shown in FIG. 3, the light source array A has a first side A1, a second side A2, a third side A3 and a fourth side A4. The first side A1 is disposed opposite to the fourth side A4. The second side A2 is disposed opposite to the third side A3. The first side A1 is disposed next to the second side A2 and the third side A3. The fourth side A4 is also disposed next to the second side A2 and the third side A3. The first electrode layer 13 is disposed adjacent to the first side A1 of the light source array A. The second electrode layer 14 is disposed adjacent to the second side A2 and the third side A3. The first electrode 13 and the second electrode layer 14 are electrically isolated from each other.

Each light emitting unit 121 has a P-type semiconductor, an N-type semiconductor, and a light-emitting layer (active layer) disposed between the P-type semiconductor and the N-type semiconductor. The N-type semiconductor is electrically connected to the first electrode layer 13. The P-type semiconductor is electrically connected to the second electrode layer 14. The light emitting layer has a light emitting portion 1211 formed at the fourth side A4 of the light source array A.

The step of forming the light source module (step S2) further includes configuring all the light emitting portions of the light emitting units 121 to emit light in a light emitting direction L. Therefore, light generated by the electrons and electron holes in the light emitting layer is emitted from the light emitting portion 1211 in the light emitting direction L.

The step of forming the light source module (step S2) further includes configuring the light emitting units 121 in such a way that the light emitting units 121 are individually controlled to emit light. The N-type semiconductor of each light emitting unit 121 is connected to the first electrode layer 13 with two pins. One pin is configured to provide an electric current, and the other pin is configured to control whether the light emitting layer lights up, so that the light emitting units 121 can be individually controlled to emit light.

Step S3 is a step for providing a circuit board 20 that may be a rigid circuit board made of epoxy resin and glass fiber or a flexible circuit board made of Polyimide (PI).

The process goes to step S4. Step S4 is a step of installing the light source module. In step S4, the light source module 10 is disposed on the circuit board 20. The first electrode layer 13 and the second electrode layer 14 of the light source module 10 are electrically connected to the circuits of the circuit board 20. By such arrangement, the circuits of the circuit board 20 can provide electric currents for the light source module 10 and control the light source module 10 to emit light. The bearing surface 111 of the substrate 11 of the light source module 10 is perpendicular to the circuit board 20. The first side A1 of the light source array A is disposed close to the circuit board 20. The fourth side A4 of the light source array A is disposed distant from the circuit board 20. By such arrangement, the light emitting direction L of the light emitting portion 1211 of the light emitting unit 121 is perpendicular to the circuit board 20 without requiring any prisms to change the light path.

The process goes to step S5. Step S5 is a step of providing the cover 30. In step S5, a cover 30 having a light permeable portion 31 is provided. In this embodiment, the cover 30 has a light permeable portion 31 and side walls 32. In this embodiment, the light permeable portion 31 is a plane lens. For example, the light permeable portion 31 is a double-sided coated plane lens to avoid light reflection.

The process goes to step S6. Step S6 is a step of installing the cover 30. In step S6, the cover 30 is disposed on the circuit board 20 to form an accommodating space S, with the light source module 10 disposed therein and the light emitting portion 1211 of the light emitting unit 121 of the light source module 10 corresponded to the light permeable portion 31. The light source module 10 is surrounded by the side walls 32 of the cover 30. The light permeable portion 31 is disposed at an end of the side walls 32 and corresponded to the light emitting portion 1211 of the light emitting unit 121 of the light source module 10. The light emitting direction L of the light emitting portion 1211 of the light emitting unit 121 extends through the light permeable portion 31. The accommodating space S is formed into a vacuum space.

The process goes to step S7. Step S7 is a step of proving a beam adjusting module. In step S7, the beam adjusting module 40 is provided.

The process goes to step S8. Step S8 is a step of installing a beam adjusting module. In step S8, the beam adjusting module 40 is disposed corresponding to the light permeable portion 31 of the cover 30, so that the light emitted by the light emitting portion 1211 of the light emitting unit 121 can pass through the beam adjusting module 40 to form a working light beam. The step of installing the beam adjusting module includes placing the fast axis collimator 41 close to the light permeable portion 31 of the cover 30. Specifically, the first columnar portion 412 of the fast axis collimator 41 is placed close to the light permeable portion 31 of the cover 30.

The invention provides a process of assembling a light source structure, wherein multiple light emitting units are provided to form a light source elements, multiple light source elements are provided to form a light source array, and the light source array is covered by a cover. The light emitting units are individually controlled to emit light. In this way, the accuracy of light beam emission can be increased, and the subsequent adjustment and calibration process of light beam projection can be simplified. Further, the operation of welding laser diodes to the circuit board that is performed in the prior art is not required in the invention. Therefore, the assembly process can be simplified and the required accuracy can be easily reached.

Further, the light emitting direction of the light emitting portion of the light emitting unit is perpendicular to the circuit board. No prisms for changing the traveling direction of the light beams are required. Therefore, the elements of the light source structure can be reduced in number.

The slow axis collimator and the fast axis collimator are integrally formed as a continuous piece. In this way, there is no need to separately install the fast axis collimator and the slow axis collimator that is performed in the prior art and that requires the subsequent adjustment and calibration process when the fast axis collimator and the slow axis collimator are installed.

What are described above are only the preferred embodiments of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention. Further, the terms “first” and “second” described in the specification and claims are only used to distinguish between different elements, embodiments or scopes, without limiting the quantity of the elements with an upper limit or a lower limit.

What is claimed is:

1. A light source structure, comprising:
a light source module comprising a substrate and at least one light source element, wherein the substrate comprises a bearing surface, the light source element is disposed on the bearing surface and comprises a plurality of light emitting units, and each of the light emitting units comprises a light emitting portion;
a circuit board on which the light source module is disposed;
a cover disposed on the circuit board to cover the light source module, wherein the cover is a continuous piece and comprises a light permeable portion, and the light emitting portion is disposed to face the light permeable portion;
a beam adjusting module disposed close to the light permeable portion of the cover, wherein light emitted from the light emitting portion passes through the light permeable portion and the beam adjusting module to form a working light beam.

2. The light source structure as claimed in claim 1, wherein the light emitting units are individually controlled to emit the light, the light is emitted by the light emitting portion in a light emitting direction, the bearing surface of the substrate is perpendicular to the circuit board, the light emitting direction is away from and perpendicular to the circuit board, the light permeable portion of the cover is a plane lens, the substrate has electrical insulation and thermal conductivity, and heat generated by the light emitting units during operation is conducted to the substrate to be dissipated.

3. The light source structure as claimed in claim 1, wherein the light source module comprises a plurality of light source elements arranged into an light source array, each of the light source elements have the same number of light emitting units or a different number of light emitting units, and the light emitting units are semiconductor light emitting units.

4. The light source structure as claimed in claim 3, wherein the light emitting units of each of the light source elements are greater than or equal to two and less than or equal to eight in number, and the light emitting units are laser diode dice or vertical cavity surface emitting laser.

5. The light source structure as claimed in claim 3, wherein the light emitting units of each of the light source elements are four in number.

6. The light source structure as claimed in claim 3, wherein:
the light source array comprises a first side, a second side, a third side and a fourth side, the first side is disposed opposite to the fourth side, the second side is disposed opposite to the third side, the first side is disposed next to the second side and the third side;
the light source further comprises a first electrode layer and a second electrode layer, the first electrode layer and the second electrode layer are disposed on the bearing surface of the substrate, the first electrode and the second electrode layer are electrically connected to the circuit board, the first electrode layer is disposed adjacent to the first side of the light source array, the second electrode layer is disposed adjacent to the second side and the third side of the light source array, and the light emitting portion is disposed adjacent to the four side of the light source array.

7. The light source structure as claimed in claim 1, wherein the beam adjusting module comprises a fast axis collimator disposed adjacent to the light permeable portion of the cover, and the light emitted from the light emitting portion sequentially passes through the light permeable portion and the fast axis collimator.

8. The light source structure as claimed in claim 7, wherein the beam adjusting module further comprises a slow axis collimator integrally formed with the fast axis collimator to be a continuous structure, and the light emitted from the light emitting portion sequentially passes through the light permeable portion, the fast axis collimator and the slow axis collimator.

9. The light source structure as claimed in claim 8, wherein the fast axis collimator comprises a convex lens portion and a first columnar portion connected to the convex lens portion, the slow axis collimator comprises a concave lens portion and a second columnar portion connected to the concave lens portion, the first columnar portion and the second columnar portion are connected, the light sequentially passes through the convex lens portion, the first columnar portion, the second columnar portion, and the concave lens portion, the convex lens portion is configured to deflect the light in a first direction, the concave lens portion is configured to deflect the light in a second direction, and the second direction is perpendicular to the first direction.

10. The light source structure as claimed in claim 1, wherein the beam adjusting module comprises a slow axis collimator, the slow axis collimator is disposed to face the light permeable portion of the cover, and the light emitted from the light emitting portion sequentially passes through the light permeable portion and the slow axis collimator.

11. The light source structure as claimed in claim 1, wherein:
the light emitting portion has a horizontal width dx, a vertical width dy, a horizontal lighting angle θx and a vertical lighting angle θy;
the horizontal width dx is a measurement parallel to the bearing surface;
the vertical width dy is a measurement perpendicular to the bearing surface;
the horizontal width dx satisfies 200 μm≤dx≤400 μm;
the vertical width dy satisfies 0.5 μm≤dy≤15 μm;
the horizontal lighting angle θx satisfies 8°≤θx≤15°;
the vertical lighting angle θy satisfies 20°≤θx≤40°;
a ratio of the vertical lighting angle θy to the horizontal lighting angle θx satisfies 2≤θy/θx≤4;
two adjacent light emitting portions are spaced at an interval, and has two center points that have a distance therebetween;
a ratio of the interval to the distance is ranged from 20% to 40%.

12. The light source structure as claimed in claim 1, wherein:
the light emitting portion has a horizontal width dx, a vertical width dy, a horizontal lighting angle θx and a vertical lighting angle θy;
the horizontal width dx is a measurement parallel to the bearing surface;
the vertical width dy is a measurement perpendicular to the bearing surface;
the horizontal width dx satisfies 348.25 μm≤dx≤351.75 μm;
the vertical width dy satisfies 0.995 μm≤dy≤1.005 μm;
the horizontal lighting angle θx satisfies 9.95°≤θx≤10.05°;
the vertical lighting angle θy satisfies 32.835°≤θy≤33.165°;
two adjacent light emitting portions are spaced at an interval, and has two center points that have a distance therebetween in a horizontal direction;
the distance is greater than or equal to 4970.5 μm, and is less than or equal to 502.5 μm;
the interval is greater than or equal to 1490.25 μm, and less than or equal to 150.75 μm.

13. An optical radar device, comprising:
a housing comprising a transparent window;
the light source structure as claimed in claim 1 that is disposed in the housing;
a scanning element comprising a plurality of reflecting mirrors and being rotatable about an axis;
a light receiving element disposed in the housing to face the window;
a calculation control unit electrically connected to the light source structure, the scanning element and the light receiving element;
wherein the working light beam is emitted from the light source structure, the scanning element is rotated so that the working light beam is reflected by one of the reflecting mirrors to an exterior through the window, an emission angle of the working light beam changes with time, the working light beam is reflected by an external object to be received by the light receiving element, and a distance of the external object is calculated by the calculation control unit based on information about emission and reception of the working light beam.

14. A process of assembling a light source structure, comprising:
providing a substrate that comprises a bearing surface;
forming at least one light source element on the bearing surface wherein the light source element and the substrate constitute a light source module, the light source element comprises a plurality of light emitting units, and each of the light emitting units comprises a light emitting portion;
providing a circuit board;
installing the light source module on the circuit board;
providing a cover that is a continuous piece and comprises a light permeable portion;
placing the cover on the circuit board to form an accommodating space, with the light source module disposed therein and the light emitting portion corresponded to the light permeable portion;
forming the accommodating space into a vacuum space;
providing a beam adjusting module; and
placing the beam adjusting module corresponding to the light permeable portion so that light emitted from the light emitting portion can pass through the beam adjusting module to form a working light beam.

15. The process of assembling a light source structure as claimed in claim 14, wherein:
the light emitting units are individually controlled to emit the light from the light emitting portion;
the light emitting portions emit the light in the same direction;
a plurality of light source elements are formed on the bearing surface;
the light source elements are arranged into an array;
the bearing surface of the substrate is perpendicular to the circuit board.

16. The process of assembling a light source structure as claimed in claim 14, wherein:
the beam adjusting module comprises a fast axis collimator and a slow axis collimator integrally formed with the fast axis collimator to be a continuous structure;
the fast axis collimator comprises a convex lens portion and a first columnar portion connected to the convex lens portion, the slow axis collimator comprises a concave lens portion and a second columnar portion connected to the concave lens portion, and the first columnar portion and the second columnar portion are connected to be another continuous structure;
the fast axis collimator is disposed adjacent to the light permeable portion of the cover;
the first columnar portion is disposed adjacent to the light permeable portion of the cover.

17. The process of assembling a light source structure as claimed in claim 14, wherein:
the light emitting units are less than or equal to eight in number;
the beam adjusting module comprises a slow axis collimator;
the slow axis collimator is disposed adjacent to the light permeable portion of the cover.

18. The process of assembling a light source structure as claimed in claim 17, wherein the light emitting units are four in number.

19. The process of assembling a light source structure as claimed in claim 14, wherein:
the light emitting portion has a horizontal width dx, a vertical width dy, a horizontal lighting angle θx and a vertical lighting angle θy;
the horizontal width dx is a measurement parallel to the bearing surface;
the vertical width dy is a measurement perpendicular to the bearing surface;
the horizontal width dx satisfies 200 μm≤dx≤400 μm;
the vertical width dy satisfies 0.5 μm≤dy≤15 μm;
the horizontal lighting angle θx satisfies 8°≤θx≤15°;
the vertical lighting angle θy satisfies 20°≤θx≤40°;
a ratio of the vertical lighting angle θy to the horizontal lighting angle θx satisfies 2≤θy/θx′4;
two adjacent light emitting portions are spaced at an interval, and has two center points that have a distance therebetween;
a ratio of the interval to the distance is ranged from 20% to 40%.

20. The process of assembling a light source structure as claimed in claim 14, wherein:
the light emitting portion has a horizontal width dx, a vertical width dy, a horizontal lighting angle θx and a vertical lighting angle θy;
the horizontal width dx is a measurement parallel to the bearing surface;
the vertical width dy is a measurement perpendicular to the bearing surface;
the horizontal width dx satisfies 348.25 μm≤dx≤351.75 μm;
the vertical width dy satisfies 0.995 μm≤dy≤1.005 μm;
the horizontal lighting angle θx satisfies 9.95°≤θx≤10.05°;
the vertical lighting angle θy satisfies 320.835°≤θy≤330.165°;
two adjacent light emitting portions are spaced at an interval, and has two center points that have a distance therebetween in a horizontal direction;
the distance is greater than or equal to 497.5 μm, and is less than or equal to 502.5 μm;
the interval is greater than or equal to 149.25 μm, and less than or equal to 150.75 μm.
